(19) United States
(12) Patent Application Publication
(10) Pub. No.: US 2022/0408823 A1
(43) Pub. Date: Dec. 29, 2022

(54) NON-COMBUSTIBLE AEROSOL PROVISION DEVICE AND A METHOD OF HEATING AN AEROSOL-GENERATING MATERIAL

(71) Applicant: Nicoventures Trading Limited, London (GB)

(72) Inventors: Patrick MOLONEY, London (GB); Walid ABI AOUN, London (GB); Anton KORUS, London (GB)

(21) Appl. No.: 17/780,232

(22) PCT Filed: Nov. 27, 2019
(86) PCT No.: PCT/EP2020/083804

§ 371 Date: May 26, 2022

(30) Foreign Application Priority Data
Nov. 29, 2019 (GB) 1917464.8

(51) Int. Cl. A24F 40/465; A24F 40/30

(52) U.S. Cl. CPC A24F 40/465; A24F 40/30

(57) ABSTRACT

A non-combustible aerosol provision device for generating an aerosol from an article, comprising an aerosol-generating material, the device including a receptacle to receive, in use, the article; a heating system for heating the aerosol-generating material when the article is received in the receptacle, wherein at least one part of the heating system and the receptacle are relatively movable; a selector operable to select one or more portions of the aerosol-generating material, from a plurality of portions of the aerosol-generating material, for heating by the heating system; and a controller configured to cause at least the part of the heating system to move relative to the receptacle to be positioned such that, in use, the one or more portions of the aerosol-generating material is, or are, heatable by the heating system.

### RELATED APPLICATION INFORMATION

The present application is a National Phase entry of PCT Application No. PCT/EP2020/083804, filed Nov. 27, 2020, which claims priority from GB Patent Application No. 1917464.8, filed Nov. 29, 2019, each of which is hereby fully incorporated herein by reference.

### TECHNICAL FIELD

The present invention relates to an aerosol provision system, a non-combustible aerosol provision device, and a method of heating an aerosol-generating material.

### BACKGROUND

Smoking articles such as cigarettes, cigars and the like bum tobacco during use to create tobacco smoke. Attempts have been made to provide alternatives to these articles that bum tobacco by creating products that release compounds without burning.

Examples of such articles are heating devices which release compounds by heating, but not burning, the material. The material may be, for example, tobacco or other non-tobacco products, which may or may not contain nicotine. Heating tobacco or non-tobacco products may volatilise at least one component of the tobacco or non-tobacco products, typically to form an aerosol which can be inhaled, without burning or combusting the tobacco or non-tobacco products.

A heating device that heats the tobacco or non-tobacco product may be described as a ‘heat-not-bum’ apparatus or a ‘tobacco heating product’ (THP) or ‘tobacco heating device’ or similar. Various arrangements have been tried for volatilising at least one component of tobacco or non-tobacco products.

### SUMMARY

A first aspect of the invention provides a non-combustible aerosol provision device for generating an aerosol from an article comprising an aerosol-generating material. The non-combustible aerosol provision device comprises: a receptacle to receive, in use, the article; a heating system for heating the aerosol-generating material when the article is received in the receptacle, wherein at least one part of the heating system and the receptacle are relatively movable; a selector operable to select one or more portions of the aerosol-generating material, from a plurality of portions of the aerosol generating material, for heating by the heating system; and a controller configured to cause at least the part of the heating system to move relative to the receptacle to be positioned such that, in use, the one or more portions of the aerosol-generating material is, or are, heatable by the heating system.

In some examples, the at least one part of the heating system is rotatable relative to the receptacle around a first axis of the receptacle. In some examples, the device comprises a rotary actuator to drive rotation of the at least one part of the heating system.

In some examples, the at least one part of the heating system is translatable relative to the receptacle in the direction of a second axis of the receptacle. In some examples, the device comprises a linear actuator to drive translation of the at least one part of the heating system.

In some examples, the at least one part of the heating system comprises a plurality of parts of the heating system and each of the parts of the heating system is movable, in use, relative to the receptacle, to heat different ones of the plurality of portions of the aerosol-generating material.

In some examples, the controller is configured to cause the at least one part of the heating system to heat the plurality of portions of the aerosol-generating material in a non-successive order.

In some examples, the heating system comprises a resistive heating system and the at least one part is an electrically resistive heater.

In some examples, the heating system comprises an induction heating system.

In some examples, the induction heating system comprises a susceptor and an induction coil operable to cause heating of the susceptor in use.

In some examples, the at least one part comprises the susceptor wherein the induction coil is fixed in position relative to the receptacle.

In some examples, the at least one pan comprises the susceptor and the induction coil.

In some examples, the induction coil is movable in unison with the susceptor.

In some examples, the at least one part comprises the induction coil and the susceptor is fixed relative to the receptacle.

In some examples, the susceptor is located radially inwards of the induction coil.

A second aspect of the invention provides a non-combustible aerosol provision device for generating an aerosol from an ankle comprising an aerosol-generating material. The non-combustible aerosol provision device comprises: a receptacle to receive, in use, the article; and an induction heating system for causing heating of the aerosol-generating material when the article is received in the receptacle, the induction heating system comprising at least one of a susceptor and an induction coil; at least one of the susceptor and the induction coil is movable relative to the receptacle such that, in use, at least one portion of a plurality of portions of the aerosol generating material is heatable by the induction heating system.

In some examples, the susceptor and the induction coil are movable relative to the receptacle.

In some examples, the induction coil is movable in unison with the susceptor.

In some examples, the induction coil is movable relative to the receptacle.

In some examples, the induction heating system comprises the susceptor and the susceptor is fixed in position relative to the receptacle.

In some examples, the susceptor is located radially inwards of the induction coil.

A fourth aspect of the invention provides a noncombustible aerosol provision system comprising: a non-combustible aerosol provision device of the first aspect or the second aspect; and at least one article comprising an aerosol-generating material, wherein the at least one article is shaped and sized to be receivable within the receptacle. The article may have any of the of the example features as described herein.

A fifth aspect of the invention provides a non-combustible aerosol provision system. The non-combustible aerosol provision system comprises: a non-combustible aerosol provision device, an article comprising an aerosol-generating material, and an induction heating system comprising at least one susceptor and at least one induction coil operable to cause heating of the susceptor in use. The non-combustible aerosol provision device comprises a receptacle to receive, in use, the article. The article is shaped and sized to be receivable within the receptacle. The non-combustible aerosol provision device comprises the at least one induction coil and the at least one induction coil and the receptacle are relatively movable. The article comprises the at least one susceptor. The article may have any of the of the example features as described herein.

In some examples, the at least one susceptor comprises a plurality of susceptors, and each of the susceptors is associated with one or more discrete portions of a plurality of portions of the aerosol generating material.

In some examples, the article is flat in shape, and the at least one induction coil is a flattened tubular shape.

In any of the aspects of the invention in which the non-combustible aerosol provision system, the non-combustible aerosol provision device, and/or the article comprise a susceptor, the susceptor, in certain examples, may comprise a homogeneous, or substantially homogeneous, material. In certain examples, the susceptor may comprise one or more materials selected from the group consisting of: an electrically-conductive material, a magnetic material, and a magnetic electrically-conductive material. In certain examples, the susceptor may comprise a metal or a metal alloy. In certain examples, the susceptor may comprise one or more materials selected from the group consisting of: aluminium, gold, iron, nickel, cobalt, conductive carbon, graphite, plain-carbon steel, stainless steel, terrific stainless steel, steel, molybdenum, silicon carbide, copper, and bronze.

A fifth aspect of the invention provides a method of heating an aerosol-generating material. The method comprises: receiving an article comprising an aerosol-generating material in a receptacle of a non-combustible aerosol provision device, the device comprising heating system for heating the aerosol-generating material; selecting one or more portions of the aerosol-generating material, from a plurality of portions of the aerosol-generating material, for heating by the heating system; moving at least one part of the heating system relative to the receptacle to be positioned such that the one or more portions of the aerosol-generating material is heatable by the heating system; and heating the one or more portions of the aerosol-generating material, using the heating system.

In some examples, the method comprises moving the at least one part of the heating system relative to the receptacle to be positioned such that a second portion of the aerosol-generating material is heatable by the heating system.

In some examples, the method comprises: re-selecting the one or more portions of the aerosol generating material for heating by the heating system; moving the at least one part of the heating system relative to the receptacle to be positioned such that the one or more portions of the aerosol-generating material is heatable by the heating system; and re-heating the one or more portions of the aerosol generating material using the heating system.

Further features and advantages will become apparent from the following detailed description of certain examples, which are described with reference to the accompanying drawings.

### BRIEF DESCRIPTION OF THE DRAWINGS

Certain examples will now be described with reference to accompanying drawings, in which:

FIG. 1 schematically illustrates an example of an aerosol provision system comprising a non-combustible aerosol provision device and an article comprising an aerosol generating material;

FIG. 2 schematically illustrates another example of an aerosol provision system comprising a non-combustible aerosol provision device and an article comprising an aerosol-generating material;

FIG. 3 schematically illustrates another example of an aerosol provision system comprising a non-combustible aerosol provision device and an article comprising an aerosol-generating material;

FIG. 4 schematically illustrates another example of an aerosol provision system comprising a non-combustible aerosol provision device and an article comprising an aerosol-generating material;

FIG. 5 schematically illustrates another example of an aerosol provision system comprising a non-combustible aerosol provision device and an article comprising an aerosol-generating material;

FIG. 6 schematically illustrates another example of an aerosol provision system comprising a non-combustible aerosol provision device and an article comprising an aerosol-generating material;

FIG. 7A schematically illustrates an example of an article comprising an aerosol-generating material from which an aerosol may be generated or formed;

FIG. 7B schematically illustrates an example of an induction heating system comprising at least one susceptor and at least one induction coil in which the article of FIG. 7A comprises the at least one susceptor; and

FIG. 8 schematically illustrates another example of an aerosol provision system comprising a non-combustible aerosol provision device and an article comprising an aerosol-generating material.

### DETAILED DESCRIPTION

Tobacco and/or non-tobacco products, of which at least one component is to be volatised, may be described as aerosol-generating material(s).

Aerosol-generating material is a material that is capable of generating aerosol, for example when heated, irradiated or energized in any other way. The aerosol generated from the aerosol generating material may facilitate the delivery of at least one substance to a user, such as by way of the user inhaling the generated aerosol, for example.

Aerosol-generating material may, for example, be in the form of a solid, liquid or gel which may or may not contain an active substance and/or flavorants. In some embodiments, the aerosol generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or [0046] The aerosol-generating material or the amorphous solid may comprise one or more active substances and/or flavors, one or more aerosol-former materials, and optionally one or more other functional material.

The active substance as used herein may be a physiologically active material, which is a material intended to achieve or enhance a physiological response. The aerosol generated from the aerosol-generating material may contain the active substance such that, in certain examples, the substance to be delivered to the user may comprise the active substance. The active substance may for example be selected from nutraceuticals, nootropics, psychoactives. The active substance may be naturally occurring or synthetically obtained. The active substance may comprise for example nicotine, caffeine, taurine, theipe, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, magoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita, c.v, Mentha spicata crispa, Mentha cardifolia, Mentha longifolia, Mentha suaveolens variegata, Mentha pulegium, Mentha spicata c.v. and Mentha suaveolens.

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

The aerosol-generating material may, in certain examples, include a ‘flavor’, that is a material that adds a flavor to a generated aerosol. Thus, in certain examples, the substance to be delivered to the user may comprise a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian apices, Asian spices, herb, wintergreen, cherry, berry, red berry, cranberry, peach, apple, orange, mango, clementine, lemon, lime, tropical fruit, papaya, rhubarb, grape, darian, dragon fruit, cucumber, blueberry, mulberry, citrus fruits. Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint, oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, eiderflower, basil, bay leaves, cumin, oregano, paprika, rosemary, saffron, lemon peel, mint, beefsteak plant, curcuma, cilantro, myrtle, cassis, valerian, pimento, mace, damien, maqoram, olive, lemon balm, lemon basil, chive, carvi, verbena, tarragon, limonene, thvinol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-former material may comprise one or more constituents capable of forming an aerosol or promoting the generation of an aerosol. In certain examples, the aerosol-former material may promote the generation of an aerosol by promoting an initial vaporisation and/or the condensation of a gas to an inhalable solid and/or liquid aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

In some embodiments, the aerosol former comprises one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate.

The one or more other functional materials may comprise one or more of pH regulators, coloring agents, preservatives, binders, fdlers, stabilizers, and/or antioxidants.

In certain examples, the aerosol-generating material may be a tobacco material. In certain examples, the aerosol-generating material may contain a nicotine source and no tobacco material. In certain examples, the aerosol-generating material may contain a tobacco material and a separate nicotine source. In certain examples, the aerosol-generating material may not contain a nicotine source.

In examples where the aerosol-generating material comprises a gel, the gel may comprise a nicotine source. In some examples, the gel may comprise a tobacco material. In some cases, the gel may comprise a tobacco material and a separate nicotine source. For example, the gel may additionally comprise powdered tobacco and/or nicotine and/or a tobacco extract.

In some examples, the aerosol-generating material or the amorphous solid comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannabigerol (CBG), camiabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM) and cannabielsoin (CBE), cannabicitran (CBT).

The aerosol-generating material or the amorphous solid may comprise one or more cannabinoid compounds selected from the group consisting of cannabidiol (CBD) and THC (tetrahydrocannabinol).

The aerosol-generating material or the amorphous solid may comprise cannabidiol (CBD).

The aerosol-generating material or the amorphous solid may comprise nicotine and cannabidiol (CBD).

The aerosol generating; maternal or the amorphous solid may comprise nicotine, cannabidiol (CBD), and THC (tetrahydrocamiabinol).

The aerosol-generating material or the amorphous solid may comprise an acid. The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid.

In some such embodiments, the acid may be at least one of succinic acid, lactic acid, benzoic acid, citric acid, tartaric acid, fumaric acid, levulinic acid, acetic acid, malic acid, formic acid, sorbic acid, benzoic acid, propanoic and pyruvic acid.

Suitably the acid is lactic acid. In other embodiments, the acid is benzoic acid. In other embodiments the acid may be an inorganic acid. In some of these embodiments the acid may be a mineral acid. In some such embodiments, the acid may be at least one of sulphuric acid, hydrochloric acid, boric acid and phosphoric acid. In some embodiments, the acid is levulinic acid.

In certain examples where the aerosol generating material or the amorphous solid comprises a gel, the gel may comprise a gelling agent. The gelling agent may comprise a hydrocolloid. In certain examples where the aerosol-generating material comprises a gel, the gel may comprise a hydrogel. The gel may additionally comprise a solvent.

The gelling agent may comprise one or more compounds selected from cellulosic gelling agents, non-cellulosic gelling, agents, guar gum, acacia gum and mixtures thereof.

In certain examples, the cellulosic gelling agent is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In certain examples, the gelling agent comprises (or is) one or more of hydroxyethyl cellulose, hydroxypropyl cellulose, hydroxypropyl methylcellulose (HPMC), carboxymethylcellulose, guar gum, or acacia gum.

In certain examples, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In preferred embodiments, the non-cellulose based gelling agent is alginate or agar.

In certain embodiments, the aerosol-generating material or the amorphous solid comprises a gelling agent comprising a cellulosic gelling agent and/or a non-cellulosic gelling agent, an active substance and an acid.

In certain examples where the aerosol-generating material comprises an amorphous solid, the amorphous solid may comprise a colorant. The addition of a colorant may alter the visual appearance of the amorphous solid. The presence of colorant in the amorphous solid may enhance the visual appearance of the amorphous solid and the aerosol-generating material. By adding a colorant to the amorphous solid, the amorphous solid may be color matched to other components of the aerosol generating material or to other components of an article comprising the amorphous solid.

In these examples, a variety of colorants may be used depending on the desired color of the amorphous solid. The color of amorphous solid may be, for example, white, green, red, purple, blue, brown or black. Other colors are also envisaged. Natural or synthetic colorants, such as natural or synthetic dyes, food-grade colorants and pharmaceutical-grade colorants may be used. In certain embodiments, the colorant is caramel, which may confer the amorphous solid with a brown appearance. In such embodiments, the color of the amorphous solid may be similar to the color of other components (such as tobacco material) in an aerosol-generating material comprising the amorphous solid. In some embodiments, the addition of a colorant to the amorphous solid renders it visually indistinguishable from other components in the aerosol-generating material.

The colorant may be incorporated during the formation of the amorphous solid (e.g. when forming a slurry comprising the materials that form the amorphous solid) or it may be applied to the amorphous solid after its formation (e.g. by spraying it onto the amorphous solid).

In certain examples, where an aerosol is generated from heating an aerosol-generating material, the aerosol-generating material may be heated to temperatures between around 50° C. to around 250° C. or 300° C.

It may be noted that, in general, a vapour is a substance in the gas phase at a temperature lower than its critical temperature, which means that, for example, the vapour can be condensed to a liquid by increasing its pressure without reducing the temperature. On the other hand, in general, an aerosol is a colloid of fine solid particles or liquid droplets, in air or another gas. A colloid is a substance in which microscopically dispersed insoluble particles are suspended throughout another substance.

For reasons of convenience, as used herein, the term ‘aerosol’ should be taken as meaning an aerosol, a vapour or a combination of an aerosol and vapour.

As used herein, the term ‘tobacco material’ refers to any material comprising tobacco or derivatives thereof. The term ‘tobacco material’ may include one or more of tobacco, tobacco derivatives, expanded tobacco, reconstituted tobacco or tobacco substitutes. The tobacco material may comprise one or more of ground tobacco, tobacco fibre, cut tobacco, extruded tobacco, tobacco stein, reconstituted tobacco and/or tobacco extract.

The tobacco used to produce tobacco material may be any suitable tobacco, such as single grades or blends, cut rag or whole leaf, including Virginia and/or Burley and/or Oriental. It may also be tobacco particle ‘fines’ or dust, expanded tobacco, sterns, expanded stems, and other processed stem materials, such as cut rolled stems. The tobacco material may be a ground tobacco or a reconstituted tobacco material. The reconstituted tobacco material may comprise tobacco fibres, and may be formed by casting, a Fourdrinier-based paper making-type approach with back addition of tobacco extract, or by extrusion.

An article may be provided comprising the aerosol-generating material comprising any of, or any combination of, the features and characteristics described above.

The article may be described as, for example, a consumable. A consumable is an article comprising or consisting of aerosol-generating material, part or all of which is intended to be consumed during use by a user. The article may be described as an article comprising an aerosol-generating material from which an aerosol may be generated or formed. In some examples, the article may include other materials and one or more other components in addition to the aerosol-generating material, such as an aerosol-generating material storage area, an aerosol-generating material transfer component, an aerosol generation area, a housing, a wrapper, a mouthpiece, a filter and/or an aerosol-modifying agent. In certain examples, the article may comprise a handling feature that permits a user to handle the article without touching the aerosol-generating material.

An article may also comprise an aerosol generator, such as a heater, that emits heat to cause the aerosol-generating material to generate aerosol in use. In some embodiments, the aerosol generator is a heater configured to subject the aerosol-generating material to heat energy, so as to release one or more volatiles from the aerosol-generating material to form an aerosol. The heater may, for example, comprise combustible material, a material heatable by electrical conduction, or a susceptor as described herein.

The aerosol-generating material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises an aerosol generator, for example a susceptor as described herein. In some embodiments, the susceptor is embedded within the aerosol-generating material. In some alternative embodiments, the susceptor is on one or either side of the material.

In certain embodiments, the aerosol-generating material may be provided as a plurality of portions of aerosol-generating material. In other words, the article may comprise a plurality of portions of aerosol-generating material. In certain embodiments, the plurality of portions of aerosol -generating material may be provided as a singular or unitary body; in other words, each portion of the plurality of portions of aerosol-generating material may also be described as a region or a zone of aerosol-generating material within the overall body of aerosol-generating material. In certain embodiments, the plurality of portions of aerosol-generating material may be provided as a series of discrete or separate bodies of aerosol-generating material; in other words, each portion of the plurality of portions of aerosol generating material may also be described as distinct or apart from the remaining portions of the plurality of portions of aerosol-generating material. Providing the plurality of portions of aerosol-generating material in an article allows any of the aerosol provision systems described herein to generate aerosol from the article in a controlled manner. For instance, certain flavors or strengths of aerosol for inhalation may be chosen for release. Furthermore, certain portions of the aerosol-generating material provided on an article may be heated in a particular order or heating pattern such that aerosols of differing compositions may be released in a particular order or pattern.

An aerosol provision system may be provided comprising at least one article, which may be any of example articles comprising an aerosol-generating material as described herein, and a non-combustible aerosol provision device for generating an aerosol from an article. The non-combustible aerosol provision device may be used by a user to generate an aerosol from the aerosol-forming material of the article so that the user can then inhale the generated aerosol. The non-combustible aerosol provision device may be any of the non-combustible aerosol provision devices described herein. A non-combustible aerosol provision device according to any of the non-combustible aerosol provision devices described herein may also be provided separately.

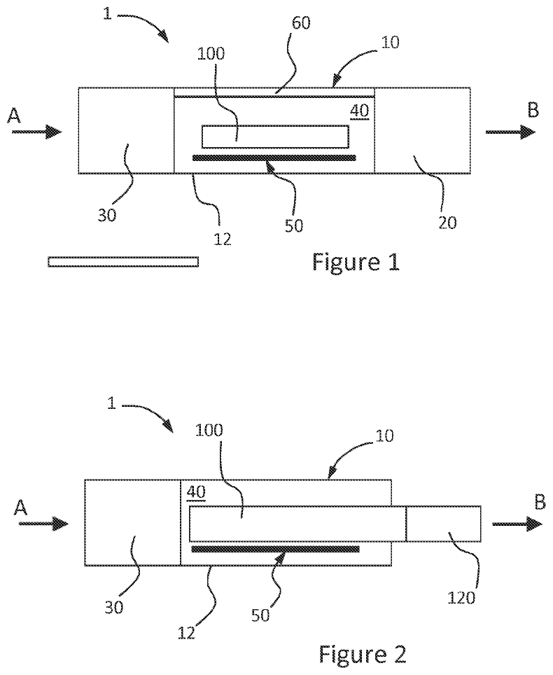

FIG. 1 shows, schematically, an example of an aerosol provision system 1. The aerosol provision system 1 comprises a non-combustible aerosol provision device 10 for generating an aerosol from an article 100. The non-combustible aerosol provision device 10 may form part of the aerosol provision system described herein. The article 100 may be an example of the article comprising an aerosol-generating material as described herein. The article 100 may be receivable in the device 10. The non-combustible aerosol provision device 10 may include a housing 12 to support and retain the various components of the device 10.

In certain examples, the non-combustible aerosol provision device 10 may include a mouthpiece 20 through which a user of the device 10 may inhale an aerosol generated in the device 10. In certain examples, the non-combustible aerosol provision device 10 may include an air inlet 30 through which air is drawn when the user inhales an aerosol generated by the device 10. In examples, the air inlet 30 may be comprise an opening in the housing 12 of the device 10. In the example shown in FIG. 1, when the user inhales, air may be drawn in the direction of arrow A and the user may inhale an aerosol in the direction of arrow B.

In other examples, such as in the example non-combustible aerosol provision device 10 shown schematically as part of the system 1 of FIG. 2, the non-combustible aerosol provision device 10 may not include a mouthpiece. For example, a user of the device 10 may inhale an aerosol generated by the device 10 from the article 100 itself. For example, the article 100 may include a mouthpiece element 120 through which a user of the device 10 may inhale an aerosol generated by the device 10. As with the device 10 of FIG. 2, in the example shown in FIG. 2, when the user inhales, air may be drawn in the direction of arrow A and the user may inhale an aerosol in the direction of arrow B.

As shown in FIGS. 1 and 2, the non-combustible aerosol provision device 10 may include a receptacle 40. The receptacle 40 may be configured to, in use, receive the article 100, such as any of the example articles described herein. In certain examples, the receptacle 40 may receive the entire body of the article 100, for example as shown in FIG. 1. In other examples, the receptacle 40 may be configured to receive a part or a portion of the article 100. An opening may be defined in the housing through which the article 100 may be inserted to be received by the receptacle 40. In some cases, where only a portion of the article 100 is received in the receptacle 40, the remaining portion of the article 100 may protrude from the opening in the housing. For example, in the case of the device 10 shown in FIG. 2, the mouthpiece element 120 of the article 100 may protrude from the opening.

The article 100 may be shaped to fit within the receptacle 40. In certain embodiments, the article 100 may be a rod, or a stick, or a pod that corresponds to the internal shape of the receptacle 40. The receptacle 40 may be configured to allow air to pass from the air inlet 30 through the receptacle 40 and out to the mouthpiece 20 or mouthpiece element 120 when the user inhales on the mouthpiece 20 or mouthpiece element 120. The air passing through the receptacle 40, when the user inhales, may collect any generated aerosol from the article 100 before entering the user's mouth.

In certain examples, the device 10 may include a lid, for example the lid 60 shown in FIG. 1. The lid 60 may seal the opening through which the article 100 may be inserted to be received by the receptacle 40. The lid 60 may be a closable lid. The lid 60, when closed, may enclose the article 100 in the device 10. The lid 60, when closed, may enclose the receptacle 40 to form an enclosed volume through which air is drawn from the air inlet 30 to the mouthpiece 20 by a user. The lid 60, when closed, may be configured to allow the aerosol generated from the article 100 to escape and be drawn through the mouthpiece 20. In certain examples of the device 10, the air inlet 30 may also act as a lid covering user access to the receptacle 40 and allowing a user to insert an aerosol forming consumable 100 into the non-combustible aerosol provision device 10.

The device 10 may include other componentry that is not shown in the examples shown in FIGS. 1 and 2. In certain examples, the on-combustible aerosol provision device 10 may have a power unit, which holds a source of power which may be, for example, a battery, for providing electrical energy to the device 10. The device 10 may have electrical circuitry connected to the power source for conducting electrical energy to other components within the device 10.

The aerosol provision system comprises a heating system. For example, the heating system 50 indicated in FIGS. 1 and 2. The heating system is for causing heating of the aerosol-generating material when an article is received in the receptacle. In certain embodiments, the non-combustible aerosol provision device may comprise the entirety of the heating system components. In certain embodiments, the article may comprise at least one component of the heating system. For instance, in some embodiments, the non-combustible aerosol provision device and the article may comprise components of the heating system.

The heating system may comprise at least one aerosol generator. For example, in certain embodiments, the heating system may comprise at least one heater. In certain embodiments, the heating system comprises more than one aerosol generator. For instance, in certain embodiments, the heating system comprises a plurality of heaters. At least one part of the heating system is movable.

In certain embodiments, the at least one part of the heating system and the receptacle are relatively movable. In certain embodiments, at least one part of the heating system is movable relative to the receptacle. In certain embodiments, the at least one part of the heating system is movable relative to the housing of the non-combustible aerosol provision device. In certain embodiments, the receptacle may be fixed relative to the housing.

In certain embodiments, the non-combustible aerosol provision device may comprise the at least one part of the heating system. In certain embodiments, the article may comprise the at least one part of the heating system. For example, the article may comprise the at least one part of the heating system and the non-combustible aerosol provision device may comprise other components of the heating system that cooperate with the at least one part of the heating system.

In certain embodiments, the at least one part of the heating system may be movable to a position such that, when the aerosol provision system is in use, one or more portions of aerosol generating material from a plurality of portions of the aerosol-generating material of the article are heatable by the heating system. For example, the at least one part of the heating system may be movable to a position where heat is applied from the aerosol generator to the one or more portions of the aerosol generating material such that an aerosol is generated from the aerosol-generating material and therefore from the article.

In certain embodiments, the at least one part of the heating system may be movable such that the one or more portions of the aerosol-generating material may be selectively heated by the aerosol generator by moving the at least one part of the heating system to a position proximate the one or more portions of the plurality of portions of the aerosol-generating material. For example, in sonic instances, moving the at least one part of the heating system to a position proximate the one or more portions of the plurality of portions of the aerosol-generating material may involve moving the aerosol generator to a position close enough to effectively transfer heat to the one or more portions of aerosol-generating material. In other examples, moving the at least one part of the heating system to a position proximate the one or more portions of the plurality of portions of the aerosol-generating material may involve moving the at least one part of the heating system, which is a part other than the aerosol generator, to a position that causes the aerosol generator to effectively transfer heat to the one or more portions of aerosol-generating material. For example, the at least one part of the heating system may be moved relative to the aerosol generator.

In certain embodiments, the at least one part of the heating system may be movable, relative to the receptacle, to a position such that one or more portions of the aerosol-generating material are heatable by the heating system. In certain embodiments, the at least one part of the heating system may be movable, relative to the housing, to a position such that one or more portions of the aerosol-generating material are heatable by the heating system.

The Applicants have identified that by heating at least one portion of the aerosol-generating material as opposed to, for example, the entirety of the aerosol-generating material, the instantaneous power required to heat the aerosol-generating material may be reduced, and therefore lower discharge rates may be required from the power unit. This may lead to a greater effective capacity of the power unit.

Furthermore, the Applicants have identified that when transferring heat to the one or more portions of aerosol-generating material, heat may also transfer into neighbouring portions of the aerosol generating material to the one or more portions of the aerosol-generating material. This may reduce the power required to heat the neighbouring portions of the aerosol-generating material.

In certain embodiments, the at least one part of the heating system may comprise a plurality of parts of the heating system. Each of the plurality of parts of the heating system may be movable, in use, to cause heating of different ones of the plurality of portions of the aerosol-generating material. For instance, each of the plurality of parts of the heating system may be independently movable, in use, relative to the receptacle or the housing, to separate positions such that different portions of the aerosol generating material are heatable by the heating system. Thus, in certain embodiments, different portions of the aerosol-generating material may be independently heated by the heating system at the same time.

In certain embodiments, the at least one pail of the heating system may operate by moving to cause the heating system to heat the plurality of portions of the aerosol-generating material in a no successive order. For instance, in some examples, the at least one part may be movable to a number of different positions such that a plurality of portions of the aerosol-generating material that are not arranged adjacent or next to each other in the article are heatable one after another. For example, a selection of the plurality of portions of the aerosol-generating material may be heated in a particular pre-determined pattern. or order in which the portion of aerosol-generating material adjacent the previously heated portion of aerosol-generating material is not the next to be heated. In some examples, the at least one part of the heating system may operate to re-heat one or more portions of the aerosol-generating material that have previously been heated by the heating system.

In certain embodiments, the receptacle may define a first axis and the at least one part of the heating system may be rotatable around the first axis of the receptacle. In certain examples, the device may comprise a rotary actuator to drive rotation of the at least one part of the heating system. In certain examples, the at least one part of the heating system may also be translatable along the first axis. In certain embodiments, the receptacle may define a second axis and the at least one part of the heating system may be translatable along the second axis. In certain examples, the device comprises a linear actuator to drive translation of the at least one heater. In certain embodiments, the at least one part of the heating system may be rotatable and translatable the about the respective first and second axes. In certain embodiments, the first and second axis may be coaxial. In certain embodiments, the receptacle may define a third axis and the at least one part of the heating system may be translatable along and/or rotatable about the third axis. For instance, where the at least one part of the heating system is translatable along the first and second axes, the at least one part of the heating system may therefore be translatable in two-dimensions across a plane of motion.

In certain embodiments, the at least one part of the heating system may comprise the at least one aerosol generator. For example, the at least one part may comprise the at least one heater. In other embodiments, for example, where the at least one pan of the heating system may comprise a plurality of heaters. In certain embodiments, where the at least one heater comprises a plurality of heaters, each of the heaters may be movable, in use, relative to the receptacle or the housing, to heat different portions of the aerosol-generating material. Thus, in certain embodiments, different portions of the aerosol generating material may be heatable by different heaters at the same time. It will be understood, as explained herein that the at least one part of the heating system may comprise one or more components of the heating system other than the aerosol generator itself. For example, one or more heaters of the heating system may be fixed in position relative to the receptacle or the housing and the at least one part of the heating system is movable relative to the receptacle or the housing. In embodiments where the article comprises the at least one part of the heating system, as discussed herein, the aerosol generator may, in some examples, be described as fixed in position when the article is received in the receptacle.

The at least one heater as described herein may be configured to heat but not bum the aerosol generating material of the article when the system is in use. By applying heat to the aerosol-generating material, the aerosol-generating material of the article may be heated thereby generating an aerosol from the aerosol-generating material. In certain embodiments, the heater may be utilised to raise the temperature of the aerosol-generating material to control the condensation of any gases on components of the article or on components of the non-combustible aerosol provision device. In such instances, the one or more portions of aerosol-generating material may not be heated to a temperature in which an aerosol is generated from the one or more portions of aerosol-generating material. In certain examples, the heater may conduct heat to the aerosol-generating material of the article. In certain examples, the heater may radiate heat to the aerosol-generating material of the article. In certain examples, the heater may heat the aerosol-generating material of the article by convection of heat to the aerosol-generating material.

In certain embodiments, the heater may comprise one or more electrically resistive heaters, including for example one or more nichrome resistive heater(s) and/or one or more ceramic heater(s). The one or more heaters may comprise one or more induction heaters which includes an arrangement comprising one or more susceptors which may form a chamber into which an article comprising aerosolizable material is inserted or otherwise located in use. Alternatively or in addition, one or more susceptors may be provided in the aerosolizable material. Other heating arrangements may also be used.

In certain embodiments, the heater may define a portion of the receptacle. For instance, the heater may form a part of the surface of the receptacle that mates—allowing for clearances and movement—with the article when it is received in the receptacle. Thus, in certain examples, the heater may form a part of the enclosing volume of the receptacle in which the aerosol is generated and exhausted when delivered to an inhaling user in use. In certain embodiments, the heater may be enclosed within the receptacle.

The heater may take any shape or form suitable for motion and/or transferring heat to the aerosol-generating material. In certain embodiments, the heater may comprise a hollow tube. A hollow tube may be particularly suitable for accommodating the article within the tube and allow effective transfer of heat from the heater to the aerosol-generating material. In other embodiments, the heater may comprise a plate, which may provide a substantially flat heat transfer surface. A flat, or plate-like, heater may be particularly suitable for transferring heat to flat or thin articles in which the aerosol-generating material is provided as a layer of material. For instance, the heater may be translated across a plane of motion above the flat article in order to transfer heat to different portions of the aerosol-generating material of the article.

In certain examples, the heater may comprise a homogeneous, or substantially homogeneous, material. In certain examples, the heater may comprise a mixture of materials. In certain examples, the heater may comprise one or more materials selected from the group consisting of: an electrically-conductive material, a magnetic material, and a magnetic electrically-conductive material.

In certain examples, the heater may be made from a metallic material. For example, the heater element may comprise a metal or a metal alloy.

In certain examples, the heater may comprise one or more materials selected from the group consisting of: aluminium, gold, iron, nickel, cobalt, conductive carbon, graphite, plain-carbon steel, stainless steel, ferritic stainless steel, steel, molybdenum, silicon carbide, copper, and bronze.

In certain examples, the heater may comprise a ceramic. In some examples, the heater may be made from a mixture of metallic and non-metallic materials. For example, the heater may be made from a metal material imbedded in a ceramic material. The ceramic material may be any suitable ceramic material, for example, but not limited to, at least one of the following alumina, zirconia, yttria, calcium carbonate, and calcium sulphate.

In use, the heating system may cause the heater to heat up, i.e. increase in temperature. Heating the heater may be performed by any suitable heating arrangement. In certain examples, the heater may be maintained at a constant temperature as the heater is moved relative to the receptacle or the housing. In certain examples, the temperature of the heater may be varied as the heater is moved relative to the receptacle or the housing. In certain embodiments, the temperature of the heater may be varied when the at least one part of the heating system is located in a position such that heat may be transferred to the one or more portions of the aerosol-generating material. In certain examples, the heating system may cause the heater to heat to a predetermined temperature before the heater begins moving. In certain examples, the heating system may be activated to cause the heater to heat up in response a user inhaling air through the device or by another means, for example by a switch.

In certain embodiments temperature and/or heat transfer sensor may be provided on the non-combustible aerosol provision device in order to monitor the temperature of the aerosol-generating material of the article and/or heat transferred to the aerosol generating material of the article. For example, a temperature sensor monitor may be installed inside the receptacle. In certain embodiments, a plurality of temperature and/or heat transfer sensors may be provided to monitor the temperature and/or heat transferred to the plurality of portions of the aerosol-generating material, where each temperature and/or heat transfer sensor corresponds to a respective portion of the plurality of portions of the aerosol generating material of the article.

In certain embodiments, the heater of the heating system may comprise an electrically resistive heater. The heating system may comprise circuitry for connecting the heater to the power source. In use, an electrical current from the power source may be passed through the electrically resistive heater to cause Joule heating of the heater. The electrically resistive heater may be any suitable material that forms an electrical conductor, for example a metallic material. When activated, in use, such that electrical current is passed through the electrically resistive heater, the one or more portions of the aerosol generating material may be heatable by the electrically resistive heater.

In certain embodiments, the heating system may comprise a thermal radiant heating system. In an example, the thermal radiant her system may comprise a heat lamp that radiates thermal energy to the heater. For example, the thermal radiant heating system may comprise an infrared light source directed at the heater. For example, the thermal radiant heating system may comprise radiant heat sources such as LEDs or LASERs.

In certain embodiments, the heating system may comprise heating the heater by conduction. For example, a heat source may be placed in contact with the heater and activated when the aerosol provision system is in use.

In certain embodiments, the heating system may comprise an induction heating system. The heating system may use induction heating to cause heating of the at least one heater. In certain embodiments, the non-combustible aerosol provision device may comprise the entirety of the induction heating system. In certain embodiments, the non-combustible aerosol provision device may comprise a portion of the components of the induction heating system. In certain embodiments, the article may comprise a portion of the induction heating system, such as at least one component of the induction heating system. Hence, in some embodiments, the non-combustible aerosol provision device and the article may comprise components of the heating system.

Induction heating is a process of heating an electrically-conductive object by electromagnetic induction. The process involves penetrating the electrically-conductive object with a varying magnetic field cause heating. The process is described by Faraday's law of induction and Ohm's law. Where the electrically conductive object is then used to heat another element then the electrically conductive object may be called a ‘susceptor’. The susceptor material may be formed of any suitable susceptor material, such as those materials identified hereinabove, for example at least one of, or any combination of, the following: iron, iron alloys such as stainless steel, mild steel, molybdenum, silicon carbide, aluminium, gold and copper.

In certain embodiments, the at least one heater may be a ‘susceptor’ in that it is heated by induction heating so that it may, in turn, may heat the aerosol-generating material of the article. The heating of the aerosol-generating material may primarily be by conducting or radiating heat to the aerosol-generating material from the heater, for example.

Arranging the heater as a susceptor may provide effective heating of the aerosol-generating material, which, in certain examples, may be substantially non-conductive. Furthermore, arranging the heater as a susceptor may allow the heat pattern of the heat directed to the aerosol-generating material of the article to be controlled.

The induction heating system may comprise an electromagnet and a device for passing a varying electric current, such as an alternating electric current, through the electromagnet. The varying electric current in the electromagnet produces a varying magnetic field. The varying magnetic field penetrates the electrically-conductive object suitably positioned with respect to the electromagnet, generating eddy currents inside the object. The object has electrical resistance to the eddy currents, and hence the flow of the eddy currents against this resistance causes the object to be heated by Joule heating, which may also be known as ohmic, or resistive heating. It has been found that, when the electrically-conductive object is in the form of a closed electrical circuit, magnetic coupling between the object and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule and magnetic hysteresis heating. In cases where the heater comprises ferromagnetic material such as iron, nickel or cobalt, heat may also be generated by magnetic hysteresis losses in the heater, i.e. by the varying orientation of magnetic dipoles in the magnetic material as a result of their alignment with the varying magnetic field.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Thus, induction heating, as compared to heating by conduction for example, may allow for rapid heating of the heater since heat is generated inside the heater (susceptor). Furthermore, as induction heating and magnetic hysteresis heating do not require a physical connection to be provided between the source of the varying magnetic field and the object, design freedom and control over the heating profile may be greater, and cost may be lower. Hence, there need not be any physical contact between the heater and the rest of the components of the inductive heating system allowing for enhanced freedom in construction, application, and reliability of the aerosol provision system.

In certain embodiments, the non-combustible aerosol provision device may comprise a selector. The selector may be operable to permit the selection of the one or more portions of the aerosol generating material of the article, from a plurality of portions of the aerosol-generating material, for heating by the heating system when the article is received in the receptacle.

In certain embodiments, the selector may be operable to permit the selection of one or more portions of a plurality of portions of the receptacle, where the one or more portions of the receptacle correspond to one or more portions of the aerosol-generating material of the article when the article is received in the receptacle. In this way, the desired one or more portions of the aerosol-generating material of the article, which have been chosen for heating by the heating system when the article is received in the receptacle, may be selected indirectly by selecting the one or more portions of the receptacle that geometrically correspond to the one or more portions of the aerosol-generating material when the article is received in the receptacle. The selection can thus, in certain embodiments, be based on the known geometric relationship between the article and the receptacle of the device.

In certain examples, the selector may be used by a user to choose a particular portion of the aerosol-generating material of the article for heating by the heating system. The user may, for instance, wish to experience inhaling an aerosol having a particular flavor and, therefore, choose a particular portion of the aerosol-generating material of the article for locating. In other instances, the user may wish to experience inhaling an aerosol having a particular strength of taste and, accordingly, choose a particular portion of the aerosol-generating material of the article for heating.

In certain examples, the selector may be operated by a user manually to choose a particular portion of the aerosol-generating material of the article for heating or choose particular portions of the aerosol-generating material for heating in a certain order. For example, switches may be provided on the device to permit the user to operate the selector.

In other examples, the selector may operate in a pre-defined manner once an article is received in the receptacle and, optionally, at the instigation of a user. For instance, the selector may be activated, once an article is received in the receptacle, to select particular portions of the aerosol-generating material for heating in a certain order. In some embodiments, the article may include an identifier, in which the identifier is operable to communicate the type, or model, of article to the non-combustible aerosol provision device when the article is received in the receptacle. The identifier may communicate to the non-combustible aerosol device information that indicates how, or in what order, particular portions of the aerosol-generating material of the article are to be heated. In other embodiments, a user may communicate to the non-combustible aerosol provision device, for instance through a user interface, information that indicates how, or in what order, particular portions of the aerosol-generating material of the article are to be heated. In other embodiments still, the non-combustible aerosol provision device may be pre-loaded with information that indicates how, or in what order, particular portions of the aerosol-generating material of the article are to be heated. For example, the information may be imputed to the non-combustible aerosol provision device when manufactured or when an order is placed by a product supplier.

In certain embodiments, the non-combustible aerosol provision device may comprise a controller. The controller may be operable to control elements of the non-combustible aerosol provision device. In embodiments, the controller may control, or cause, movement of the at least one part of the heating system. For instance, the controller may cause the at least one part of the heating system to move relative to the receptacle and/or relative to the housing. In certain embodiments, the controller may be configured to cause the at least one part of the heating system to move relative to the receptacle such that, in use, the one or more portions of the aerosol-generating material of the article is, or are, heatable by the heating system.

In certain embodiments, the controller may, in response to the selector selecting the one or more portions of aerosol-generating material of the article for heating, cause the at least one part of the heating system to move relative to the receptacle such that, in use, the one or more portions of the aerosol-generating material of the article is heatable by the heating system. For example, the controller may cause the at least one part of the heating system to move relative to the receptacle to a position where the at least one part of the heating system is proximate the one or more portions of aerosol generating material so that heat may be transferred to the aerosol-generating material when the heating system is active to cause the at least one heater to be heated.

In certain embodiments, the controller may, in response to the selector selecting the one or more portions of aerosol-generating material of the article for heating, cause the at least one part of the heating system to move relative to the housing such that, in use, the one or more portions of the aerosol generating material of the article is heatable by the heating system. For example, the controller may cause the at least one part of the heating system to move relative to the housing to a position where the at least one part of the heating system is proximate the one or more portions of aerosol-generating material so that heat may be transferred to the aerosol-generating material when the heating system is active to cause the at least one heater to be heated.

In certain embodiments, the controller may comprise the selector. For instance, controller may comprise circuitry that allows the controller to perform the functions of the selector as described herein.

In certain embodiments, the controller may, once the at least one part of the heating system has moved to a position where the one or more portions of the aerosol-generating material of the article is heatable by the heating system, cause the heating system to cause heating of the at least one heater thereby heating the one or portions of aerosol-generating material. In some embodiments, the controller may cause the heating system to cause heating of the at least one heater before the motion of the at least one part of the heating system begins. In some embodiments, the controller may cause the heating system to cause heating of the at least one heater while the at least one part of the heating system is in motion and/or before reaching the position where the one or more portions of the aerosol-generating material of the article is heatable by the heating system.

A method of heating an aerosol-generating material may be provided. In certain embodiments, the method may be implemented in any of the aerosol provision systems described herein. In certain embodiments, the method may involve heating aerosol-generating material of any of the articles described herein.

The method of heating an aerosol-generating material comprises: receiving an article comprising an aerosol-generating material in a receptacle of a non-combustible aerosol provision device, in which the non-combustible aerosol provision device comprises a heating system; selecting one or more portions of a plurality of portions of the aerosol-generating material for heating by the heating system; moving at least one part of the heating system relative to the receptacle or the housing to a position such that the one or more portions of the aerosol-generating material is heatable by the heating system; and heating the one or more portions of the aerosol-generating material using the heating system. In certain embodiments, the non-combustible aerosol provision device may comprise a housing and the method may, instead, comprise moving the at least one part of the heating system relative to the housing to a position such that the one or more portions of the aerosol-generating material is heatable by the heating system. In certain embodiments, any of the movements relative to the receptacle as described herein may, instead, be movements of the heater relative to the housing. In certain embodiments, the at least one part of the heating system may comprise an aerosol generator as described herein. For example, the at least one part of the heating system may comprise a heater, such as a susceptor as described herein. [0143] In certain embodiments, the method may comprise moving the at least one part of the heating system relative to the receptacle to a position such that a second portion of the aerosol-generating material is heatable by the heating system. In some examples, the method may comprise heating, the second portion of the aerosol-generating material using the heating system. In certain embodiments, the method may comprise, for example following the movement to a position such that the second portion of the aerosol-generating material is heatable by the heating system: re-selecting the one or more portions of the aerosol-generating material for heating by the heating system; moving the at least one part of the heating system relative to the receptacle to the position such that the one or more portions of the aerosol-generating material is heatable by the heating system; and re-heating the one or more portions of the aerosol-generating material using the heating system. In this way, the amount of heat transferred to the one or portions of aerosol-generating material may be controlled and the temperature of the one or more portions of aerosol-generating material may be maintained at a desired temperature whilst, at the same time, the amount of heat transferred to the second portion of aerosol-generating material may be controlled and the temperature of the second portion of aerosol-generating material may be maintained at a second desired temperature. Furthermore, in this way, the at least one part of the heating system may be repeatedly moved to different positions proximate different portions of the aerosol-generating material of the article in order to maintain the desired respective temperatures of all the different portions of aerosol-generating material. For instance, in one example where the article is in the shape of an elongate rod, the at least one part of the heating system may be moved repeatedly backwards and forwards along the length of the rod to transfer heat into different portions of the aerosol generating material of the article and thereby maintain the desired particular temperature in each those different portions.

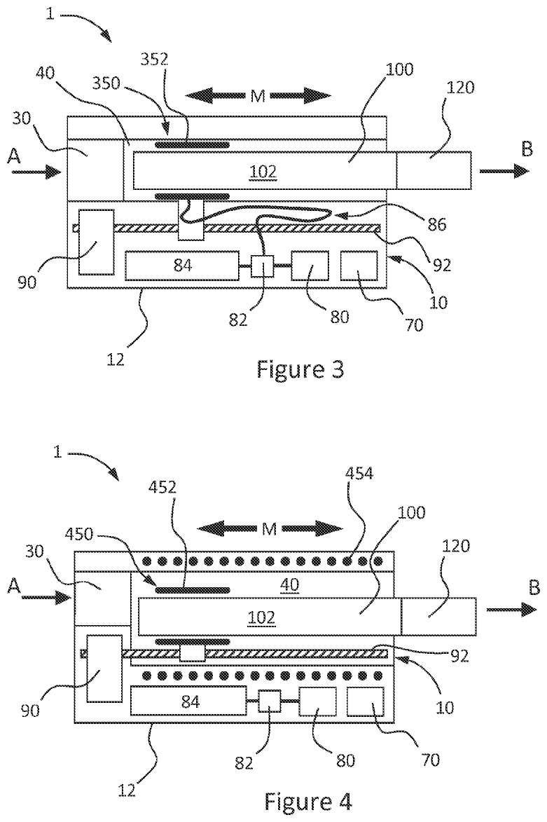

An embodiment of a system 1 comprising a non-combustible aerosol provision device 10 for generating an aerosol from an article 100 comprising aerosol-generating material is shown in FIG. 3. The aerosol-generating material may be stored in an aerosol-generating material storage area 102. In this embodiment, the heating system comprises a resistive heating system 350. The resistive system 350 is operable to cause heating of the heater. In this embodiment, the at least one part of the heating system is a heater. The heater is an electrically resistive heater 352 that may be heated by passing an electrical current as through the resistive heater 352 as described herein. In the embodiment of FIG. 3, the electrically resistive heater is movable relative to the receptacle 40.

When activated, in use, such that electrical current is passed through the electrically resistive heater 352, the one or more portions of the aerosol-generating material may be heatable by the electrically resistive heater 352.

In the aerosol provision system shown in FIG. 3, the article 100 is provided with a mouthpiece element 120 on which a user may inhale aerosol generated in the device 10. However, it will be understood that the device 10 may instead be provided with a mouthpiece as described and illustrated herein. As with the non-combustible aerosol provision device 10 illustrated in FIGS. 1 and 2, the non-combustible aerosol provision device 10 shown in FIG. 4 includes an air inlet 30. A user inserts the article 100, in accordance with the examples described herein, into the receptacle 40 of non-combustible aerosol provision device 10 through an opening in the housing 12. In other embodiments of the device, a lid covering user access to the receptacle 40, and allowing insertion of the article into the receptacle 40, may be provided.

In the embodiment shown in FIG. 3, the receptacle 40 is shaped and arranged to receive an elongate article 100 and is open at one end to allow the article 100 to be inserted into the receptacle 40. It will be understood that the receptacle 40 may be shaped and arranged to receive other shapes of article 100 as described herein.

In the example shown in FIG. 3, the electrically resistive heater 352 may be an elongate tubular shape. The electrically resistive heater 352 may be a hollow tube. A tubular shape may allow the receiving of the elongate article within the electrically resistive heater 352 when the article 100 is received in the receptacle, as is shown in FIG. 3. The electrically resistive heater 352 may be a cylindrical tubular shape, for example. In FIG. 3, the electrically resistive heater 352 is shown in cross section through an axis of the electrically resistive heater 352.

In the embodiment shown in FIG. 3, the electrically resistive heater 352 is movable in the direction of arrows M along at least a portion of the length of the receptacle 40. Thus, when the article 100 is received in the receptacle 40, the electrically resistive heater 352 is movable along at least a portion of the length of the article 100. In this way the electrically resistive heater 352 may be moved backwards and forwards along the length of the article 100 so that selected one or more portions of the aerosol-generating material may be heated by the electrically resistive heater 352 by positioning the electrically resistive heater 352 proximate to the respective portion of aerosol-generating material and activating the heating system 350.

Some embodiments of the device 10 of FIG. 3 may include a selector 70. The selector 70 is operable to select one or more portions of the aerosol-generating material from the article 100 for heating by the electrically resistive heater 352 as described herein.

In certain embodiments, the device 10 may include a controller 80. The controller 80 may be connected to other components of the device 10 by circuitry 82. For instance, the controller 80 may be connected via the circuitry 82 to a power unit 84 for supplying power to the device 10. The circuitry 82 may also connect the controller 80 and/or power unit 84 to the heating system 350. In the example shown, the heating system 350 is connected through the circuitry 82, via a wiring loom 86, or harness, to the controller 80 and/or power unit 84. The heating 350 system may also be connected via the loom 86 to the selector 70, for example through the controller 80. The controller 80 may therefore control the electrical current passing through the electrically resistive heater 352 and therefore the amount of heat generated by the electrically resistive heater 352. In use, an electrical current from the power source may be passed through the electrically resistive heater 352 to cause Joule heating of the heater. The controller 80 may control the position of the electrically resistive heater 352.

In certain examples, the wiring loom 86 is arranged to facilitate the movement of the electrically resistive heater 352. For example, the loom 86 may be folded onto itself to accommodate the movement of the electrically resistive heater 352 whilst still allowing a stable electrical connection.

In certain embodiments, the controller 80 may comprise the selector 70. In certain embodiments, the selector 70 may be separate from the controller 80. For instance, the selector 70 may be a user interface, such as a switch or touchscreen, through which a user can select one or more portions of the aerosol-generating material for heating by the electrically resistive heater 352. In some examples, the selector 70 may be connected to the controller, for instance via the circuitry 82.

The device 10 may include an actuator 90, which is operable to drive the movement of the electrically resistive heater 352. In certain embodiments, the actuator 90 may be a linear actuator to drive translation of the electrically resistive heater 352 along the length of the receptacle 40 and therefore along the length of the article 100. For example, the actuator 90 may comprise a lead screw 92 on which the electrically resistive heater 352 is mounted on a lead nut. In certain embodiments, the actuator 90 may be a rotary actuator to drive rotation of the electrically resistive heater 352 around the receptacle 40 and therefore around the outside of the article 100.

It will be understood that other actuators could be employed to drive the motion of the electrically resistive heater 352. For instance, a push-pull actuator, such as a rigid belt, a chain drive, or a magnetic drive, could be employed to drive the motion of the electrically resistive heater 352.

In the example shown in FIG. 3, the lead screw 92 of the actuator 90 is located outside of the receptacle 40. However, it will be understood that the lead screw 92 may be located inside the receptacle 40, such as in the inductive heating system described with respect to FIG. 4 below. In the example shown, the lead nut includes a support that protrudes through a wall of the receptacle 40 to connect to, and to drive motion of, the electrically resistive heater 352

The actuator 90 may be connected, via circuitry 82, to the controller 80 so that the controller 80 can control the motion of the electrically resistive heater 352 with respect to the receptacle 40.

Another embodiment of a system 1 comprising a non-combustible aerosol provision device 10 for generating an aerosol from an article 100 comprising aerosol-generating material is shown in FIG. 4. The aerosol-generating, material may be stored in an aerosol-generating material storage area 102. In this embodiment, the heating system comprises an induction heating system 450. In this embodiment, the at least one part of the heating system comprises a susceptor 452 that may be heated by induction heating as described herein. The induction heating system 450 is operable to cause heating of the susceptor 452. In the embodiment shown FIG. 4, the induction heating system 450 comprises an induction coil 454 and the susceptor 452.

in the embodiment of FIG. 4, the susceptor 452 is movable relative to the induction coil 454, which is fixed relative to the receptacle 40. The induction coil 454 may be mounted in the housing 12.

When the induction coil 454 is energised with an alternating current, as described herein, the resulting varying magnetic field beats the susceptor 452. The susceptor 452 may then be used to heat one or more portions of the aerosol-generating material of the article 100 when the device 10 is in use and an article 100 is received in the receptacle 40.

In the embodiments of the aerosol provision system shown in FIG. 4, the article 100 is provided with a mouthpiece element 120 on which a user may inhale aerosol generated in the device 10. However, it will be understood that the device 10 may instead be provided with a mouthpiece as described herein. As with the non-combustible aerosol provision device 10 illustrated in FIGS. 1 and 2, the non-combustible aerosol provision device 10 shown in FIG. 4 includes an air inlet 30. A user inserts the article 100, in accordance with the examples described herein, into the receptacle 40 of non-combustible aerosol provision device 10 through an opening in the housing 12. In other embodiments of the device, a lid covering user access to the receptacle 40, and allowing insertion of the article into the receptacle 40, may be provided.

In the embodiment shown in FIG. 4, the receptacle 40 is shaped and arranged to receive an elongate article 100 and is open at one end to allow the article 100 to be inserted into the receptacle 40. It will be understood that the receptacle 40 may be shaped and arranged to receive other shapes of article 100 as described herein.

In the example shown in FIG. 4, the induction coil 454 of the induction heating system 450 is coiled, or wrapped, around the susceptor 452. In other examples, as explained further below, the induction coil 454 may be coiled inside the susceptor 452. In certain examples, the susceptor 452 may be an elongate tubular shape. The susceptor 452 may be a hollow tube. A tubular shape may allow the receiving of the elongate article within the susceptor 452 when the article 100 is received in the receptacle, as is shown in FIG. 4. The susceptor 452 may be a cylindrical tubular shape, for example. The induction coil 454 may be also be an elongate tubular shape, for example a cylindrical tubular shape, that corresponds to the susceptor 452. In FIG. 4, the susceptor 452 and induction coil 454 are shown in cross section through the axis of the tubular coil 454.

In this embodiment, the induction coil 454 extends along substantially an entire length of the receptacle 40. Thus, in this instance, when the article 100 is received in the receptacle 40, the induction coil 454 extends substantially along an entire length of the article 100. In certain embodiments, the induction coil 454 may only extend along a portion of a length of the receptacle 40. This may be, for instance, in examples where the non-combustible aerosol provision device 10 is arranged to accommodate an article 100 in which only a portion of the article 100 supports or includes aerosol generating material. For instance, the article 100 may include a handling feature that takes up a portion of the article 100 volume and therefore takes up a corresponding portion of the receptacle 40 volume when the article 100 is received in the receptacle 40. Hence, in some examples the induction coil 454 may extend, or cover, only a portion of the length of the receptacle 40.

In the example shown in FIG. 4, the induction coil 454 is located outside of the receptacle 40. In other examples, the induction coil 454 may be located inside the receptacle 40. In the example of the non-combustible aerosol provision device shown in FIG. 4, the susceptor 452 is located inside the induction coil 454. In other words, the susceptor 452 may be located radially inward of the induction coil 454. For instance, the induction coil 454 is coiled or wrapped in a substantially cylindrical shape and the radial direction is defined relative to the by the cylindrical shape of the induction coil 454. In other examples, the susceptor 452 may be located outside the induction coil 454, such as in a radially outward direction of the induction coil 454.

In the embodiment shown in FIG. 4, the susceptor 452 is movable in the direction of arrows M along at least a portion of the length of the receptacle 40. Thus, when the article 100 is received in the receptacle 40, the susceptor 452 is movable along at least a portion of the length of the article 100. In this way the susceptor 452 may be moved backwards and forwards along the length of the article 100 so that selected one or more portions of the aerosol-generating material may be heated by the susceptor 452 by positioning the susceptor 452 proximate to the respective portion of aerosol-generating material and activating the induction heating system 450.

Some embodiments of the device 10 of FIG. 4 may include a selector 70. The selector 70 is operable to select one or more portions of the aerosol-generating material from the article 100 for heating by the susceptor 452 as described herein.

In certain embodiments, the device 10 may include a controller 80. The controller 80 may be connected to other components of the device 10 by circuitry 82. For instance, the controller 80 may be connected via the circuitry 82 to a power unit 84 for supplying power to the device 10. The circuitry 82 may also connect the controller 80 and/or power unit 84 to the induction heating system 450. For instance, the induction coil 454 may be connected to the controller 80 and power unit 84.

In certain embodiments, the controller 80 may comprise the selector 70. In certain embodiments, the selector 70 may be separate from the controller 80. For instance, the selector 70 may be a user interface, such as a switch or touchscreen, through which a user can select one or more portions of the aerosol-generating material for heating by the susceptor 452. In some examples, the selector 70 may be connected to the controller, for instance via the circuitry 82.

The device 10 may include an actuator 90, which is operable to drive the movement of the susceptor 452. In certain embodiments, the actuator 90 may be a linear actuator to drive translation of the susceptor 452 along the length of the receptacle 40 and therefore along the length of the article 100. For example, the actuator 90 may comprise a lead screw 92 on which the susceptor 452 is mounted on a lead nut. In certain embodiments, the actuator 90 may be a rotary actuator to drive rotation of the susceptor 452 around the receptacle 40 and therefore around the outside of the article 100.

It will be understood that other actuators could be employed to drive the motion of the susceptor 452. For instance, a push-pull actuator, such as a rigid belt, a chain drive, or a magnetic drive, could be employed to drive the motion of the susceptor 452.

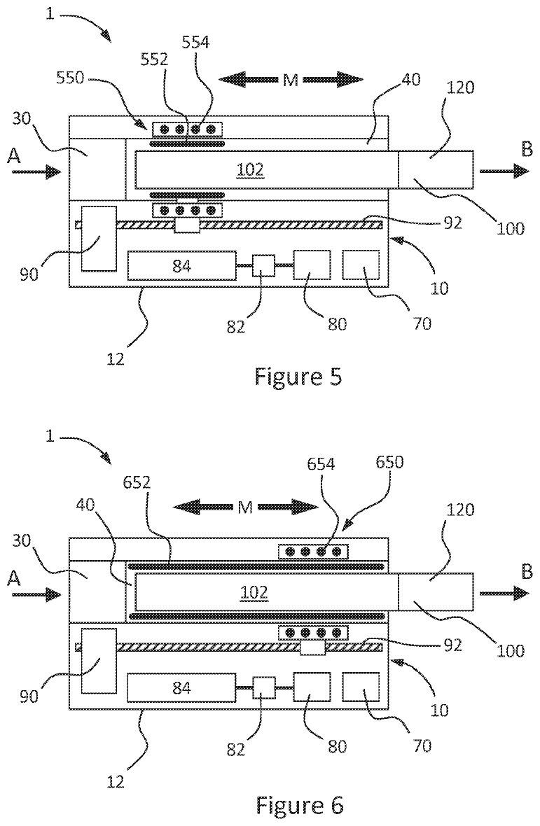

In the example shown in FIG. 4, the lead screw 92 of the actuator 90 is located inside the receptacle 40. However, it will be understood that the lead screw 92 may be located outside the receptacle (inside the housing 12), such as shown in FIG. 5.

The actuator 90 may be connected, via circuitry 82, to the controller 80 so that the controller 80 can control the motion of the susceptor 452 with respect to the receptacle 40.

Another example embodiment of a system 1 comprising a non-combustible aerosol provision device 10 for generating an aerosol from an article 100 comprising aerosol-generating material is shown in FIG. 5. The aerosol-generating material may be stored in an aerosol-generating material storage area 102. In this embodiment, the heating system comprises an induction heating system 550. In this embodiment, the at least one part of the heating system comprises a susceptor 552 that may be heated by induction heating as described herein. The induction heating system 550 is operable to cause heating of the susceptor 552. In this embodiment, the at least one part of the heating system comprises an induction coil 554. In the embodiment shown FIG. 5, the induction heating system 550 comprises the induction coil 554 and the susceptor 552.

In the embodiment of FIG. 5, the susceptor 552 is movable relative to the to the receptacle 40. In certain embodiments, the induction coil 554 is movable relative to the to the receptacle 40, which may be in unison with the susceptor 552. In the example shown in FIG. 5, the susceptor 554 and induction coil 554 are fixed together. Hence, when the susceptor 552 moves relative to the receptacle, the induction coil 554 moves with the susceptor. This arrangement may allow for a lighter and/or smaller device since a smaller induction coil may be required as the coil only needs to substantially match the size of the susceptor 552. This arrangement may also allow the more efficient use of energy since the induction coil 554 and susceptor 552 may be arranged closely together in an efficient use of space.

When the induction coil 554 is energised with an alternating current, as described herein, the resulting varying magnetic field heats the susceptor 552. The susceptor 552 may then be used to heat one or more portions of the aerosol-generating material of the article 100 when the device 10 is in use and an article 100 is received in the receptacle 40.

In the embodiment of the aerosol provision system 1 shown in FIG. 5, the article 100 is provided with a mouthpiece element 120 on which a user may inhale aerosol generated in the device 10. However, it will be understood that the device 10 may instead be provided with a mouthpiece as described herein. As with the non-combustible aerosol provision device 10 illustrated in FIGS. 1 and 2, the non-combustible aerosol provision device 10 shown in FIG. 5 includes an air inlet 30. A user inserts the article 100, in accordance with the examples described herein, into the receptacle 40 of non-combustible aerosol provision device 10 through an opening in the housing 12. In other embodiments of the device, a lid covering user access to the receptacle 40, and allowing insertion of the article 100 into the receptacle 40, may be provided.

In the embodiment shown in FIG. 5, the receptacle 40 is shaped and arranged to receive an elongate article 100 and is open at one end to allow the article 100 to be inserted into the receptacle 40. It will be understood that the receptacle 40 may be shaped and arranged to receive other shapes of article 100 as described herein.

In the example shown in FIG. 5, the induction coil 554 of the induction heating system 550 is coiled, or wrapped, around the susceptor 552. In other examples, the induction coil 554 may be coiled inside the susceptor 552. In certain examples, the susceptor 552 may be an elongate tubular shape. The susceptor 552 may be a hollow tube. A tubular shape may allow the receiving of the elongate article within the susceptor 552 when the article 100 is received in the receptacle 40, as is shown in FIG. 5. The susceptor 552 may be a cylindrical tubular shape, for example. The induction coil 554 may be also be an elongate tubular shape, for example a cylindrical tubular shape, that corresponds to the susceptor 552. In FIG. 5, the susceptor 552 and induction coil 554 are shown in cross section through the axis of the tubular coil 554 and/or susceptor 552.

In this embodiment, the induction coil 554 extends only along substantially the length of the susceptor 552. Thus, in this instance, when the article 100 is received in the receptacle 40, the induction coil 554 extends substantially along a part of the length of the article 100 corresponding to a portion of the aerosol-generating material that is to be heated.

In the example shown in FIG. 5, the induction coil 554 is located outside of the receptacle 40. In other examples, the induction coil 554 may be located inside the receptacle 40, for instance directly adjacent to the susceptor 552. In the example of the non-combustible aerosol provision device 10 shown in FIG. 5, the susceptor 552 is located inside the induction coil 554. In other words, the susceptor 552 may be located radially inward of the induction coil 554. For instance, the induction coil 554 is coiled or wrapped in a substantially cylindrical shape and the radial direction is defined relative to the by the cylindrical shape of the induction coil 554. In other examples, the susceptor 552 may be located outside the induction coil 554, such as in a radially outward direction of the induction coil 554.

In the embodiment shown in FIG. 5, the susceptor 552 is movable in the direction of arrows M along at least a portion of the length of the receptacle 40. Thus, when the article 100 is received in the receptacle 40, the susceptor 552 and the induction coil 554 are movable along at least a portion of the length of the article 100. In this way the susceptor 552 may be moved backwards and forwards along the length of the article 100 so that selected one or more portions of the aerosol-generating material may be heated by the susceptor 552 by positioning the susceptor 552 proximate to the respective portion of aerosol-generating material and activating the induction heating system 550.

Some embodiments of the device 10 of FIG. 5 may include a selector 70. The selector 70 is operable to select one or more portions of the aerosol-generating material from the article 100 for heating by the susceptor 552 as described herein.

In certain embodiments, the device 10 may include a controller 80. The controller 80 may be connected to other components of the device 10 by circuitry 82. For instance, the controller 80 may be connected via the circuitry 82 to a power unit 84 for supplying power to the device 10. The circuitry 82 may also connect the controller 80 and/or power unit 84 to the induction heating system 550. For instance, the induction coil 554 may be connected to the controller 80 and power unit 84.

In certain embodiments, the controller 80 may comprise the selector 70. In certain embodiments, the selector 70 may be separate from the controller 80. For instance, the selector 70 may be a user interface, such as a switch or touchscreen, through which a user can select one or more portions of the aerosol-generating material for heating by the susceptor 552. In some examples, the selector 70 may be connected to the controller, for instance via the circuitry 82.

The device 10 may include an actuator 90, which is operable to drive the movement of the susceptor 552 and the induction coil 554. In certain embodiments, the actuator 90 may be a linear actuator to drive translation of the susceptor 552 and induction coil 554 along the length of the receptacle 40 and therefore along the length of the article 100. For example, the actuator 90 may comprise a lead screw 92 on which the susceptor 552 and induction coil 554 are mounted on a lead nut. In certain embodiments, the actuator 90 may be a rotary actuator to drive rotation of the susceptor 552 and/or induction coil 554 around the receptacle 40 and therefore around the outside of the article 100.

It will be understood that other actuators could be employed to drive the motion of the susceptor 552 and/or the induction coil 554. For instance, a push-pull actuator, such as a rigid belt, a chain drive, or a magnetic drive, could be employed to drive the motion of the susceptor 552 and/or the induction coil 554.

In the example shown in FIG. 5, the lead screw 92 of the actuator 90 is located outside the receptacle 40. However, it will be understood that the lead screw 92 may be located inside the receptacle, such as shown in FIG. 4.

The actuator 90 may be connected, via circuitry 82, to the controller 80 so that the controller 80 can control the motion of the susceptor 552 and/or induction coil 554 with respect to the receptacle 40.

Another example embodiment of a system 1 comprising a non-combustible aerosol provision device 10 for generating an aerosol from an article 100 comprising aerosol-generating material is shown in FIG. 6. The aerosol-generating material may be stored in an aerosol-generating material storage area 102. In this embodiment, the heating system comprises an induction heating system 650. In this embodiment, the at least one part of the heating system comprises an induction coil 654. The induction heating system 650 is operable to cause heating of a susceptor 652. In the embodiment shown FIG. 6, the induction heating system 650 comprises the induction coil 654 and the susceptor 652.

In the embodiment of FIG. 6, the induction coil 554 is movable relative to the receptacle 40. The susceptor 652 is fixed relative to the receptacle 40. Thus, in certain examples, the induction coil 554 is movable relative to the susceptor 652. In the embodiment shown in FIG. 6, the susceptor 652 is part of the device 10 and may, for example, may be mounted in the housing 12 or in the receptacle 40. This arrangement may allow for a lighter and device since a smaller induction coil may be required as the coil only needs to substantially match the size of the region or portion of susceptor 652 that needs to be heated in order to heat the respective portion of aerosol-generating material. This arrangement may also allow the more efficient use of energy since the induction coil 654 and susceptor 652 may be arranged closely together in an efficient use of space. In some examples, the susceptor 652 may be formed of a plurality segments that are heat insulated from one another so that, when one segment of the susceptor 652 is heated by the induction heating system 650, there is no heat lost into neighbouring segments of the susceptor 652. In this way, the efficient use of energy can be further improved.

When the induction coil 654 is energised with an alternating current, as described herein, the resulting varying magnetic field heats the susceptor 652. The susceptor 652 may then be used to heat one or more portions of the aerosol-generating material of the article 100 when the device 10 is in use and an article 100 is received in the receptacle 40.

In the embodiment of the aerosol provision system 1 shown in FIG. 6, the article 100 is provided with a mouthpiece element 120 on which a user may inhale aerosol generated in the device 10. However, it will be understood that the device 10 may instead be provided with a mouthpiece as described herein. As with the non-combustible aerosol provision device 10 illustrated in FIGS. 1 and 2, the non-combustible aerosol provision device 10 shown in FIG. 5 includes an air inlet 30. A user inserts the article 100, in accordance with the examples described herein, into the receptacle 40 of non-combustible aerosol provision device 10 through an opening in the housing 12. In other embodiments of the device, a lid covering user access to the receptacle 40, and allowing insertion of the article 100 into the receptacle 40, may be provided.

In the embodiment shown in FIG. 6, the receptacle 40 is shaped and arranged to receive an elongate article 100 and is open at one end to allow the article 100 to be inserted into the receptacle 40. It will be understood that the receptacle 40 may be shaped and arranged to receive other shapes of article 100 as described herein.

In the example shown in FIG. 6, the induction coil 654 of the induction heating system 550 is coiled, or wrapped, around the susceptor 652. In other examples, the induction coil 654 may be coiled inside the susceptor 652. In certain examples, the susceptor 652 may be an elongate tubular shape. The susceptor 652 may be a hollow tube. A tubular shape may allow the receiving of the elongate article within the susceptor 652 when the article 100 is received in the receptacle 40, as is shown in FIG. 5. The susceptor 652 may be a cylindrical tubular shape, for example. The induction coil 654 may be also be an elongate tubular shape, for example a cylindrical tubular shape, that corresponds to the susceptor 652. In FIG. 6, the susceptor 652 and induction coil 654 are shown in cross section through the axis of the tubular coil 654 and/or susceptor 652.

In this embodiment, the induction coil 654 extends only along a portion of the length of the susceptor 652. Thus, in this instance, when the article 100 is received in the receptacle 40, the induction coil 654 extends substantially along a pan of the length of the article 100 corresponding to a portion of the aerosol-generating material that is to be heated.

In the example shown in FIG. 6, the induction coil 654 is located outside of the receptacle 40. In other examples, the induction coil 654 may be located inside the receptacle 40, for instance directly adjacent to the susceptor 652. In the example of the noncombustible aerosol provision device 10 shown in FIG. 6, the susceptor 652 is located inside the induction coil 654. In other words, the susceptor 652 may be located radially inward of the induction coil 654. For instance, the induction coil 654 is coiled or wrapped in a substantially cylindrical shape and the radial direction is defined relative to the by the cylindrical shape of the induction coil 654. In other examples, the susceptor 652 may be located outside the induction coil 654, such as in a radially outward direction of the induction coil 654.

In the embodiment shown in FIG. 6, the induction coil 654 is movable in the direction of arrows M along at least a portion of the length of the receptacle 40. Thus, when the article 100 is received in the receptacle 40, the induction coil 654 is movable along at least a portion of the length of the article 100. In this way the induction coil 654 may be moved backwards and forwards along the length of the article 100 so that selected one or more portions of the aerosol-generating material may be heated by the susceptor 652 by positioning the induction coil 654 proximate to the respective portion of the susceptor 652 corresponding to the selected one or more portions aerosol-generating material and activating the induction heating system 650.

Some embodiments of the device 10 of FIG. 6 may include a selector 70. The selector 70 is operable to select one or more portions of the aerosol-generating material from the article 100 for heating by the susceptor 652 as described herein.

In certain embodiments, the device 10 may include a controller 80. The controller 80 may be connected to other components of the device 10 by circuitry 82. For instance, the controller 80 may be connected via the circuitry 82 to a power unit 84 for supplying power to the device 10. The circuitry 82 may also connect the controller 80 and/or power unit 84 to the induction heating system 650. For instance, the induction coil 654 may be connected to the controller 80 and power unit 84.

In certain embodiments, the controller 80 may comprise the selector 70. In certain embodiments, the selector 70 may be separate from the controller 80. For instance, the selector 70 may be a user interface, such as a switch or touchscreen, through which a user can select one or more portions of the aerosol-generating material for heating by the susceptor 652. In some examples, the selector 70 may be connected to the controller, for instance via the circuitry 82.

The device 10 may include an actuator 90 which is operable to drive the movement of the induction coil 654. In certain embodiments, the actuator 90 may be a linear actuator to drive translation of the induction coil 654 along the length of the receptacle 40 and therefore along the length of the article 100. For example, the actuator 90 may comprise a lead screw 92 on which the induction coil 654 is mounted on a lead nut. In certain embodiments, the actuator 90 may be a rotary actuator to drive rotation of the induction coil 654 around the receptacle 40 and therefore around the outside of the article 100.

It will be understood that other actuators could be employed to drive the motion of the induction coil 654. For instance, a push-pull actuator, such as a rigid belt, a chain drive, or a magnetic drive, could be employed to drive the motion of the induction coil 654.

In the example shown in FIG. 6, the lead screw 92 of the actuator 90 is located outside the receptacle 40. However, it will be understood that the lead screw 92 may be located inside the receptacle, such as shown in FIG. 4.

The actuator 90 may be connected, via circuitry 82, to the controller 80 so that the controller 80 can control the motion of the induction coil 654 with respect to the receptacle 40.

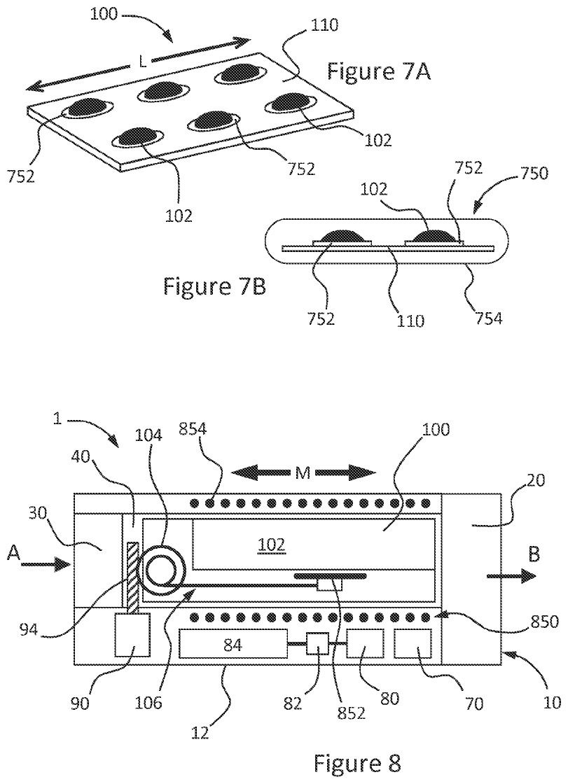

Another embodiment of an aerosol provision system 1 comprising a non-combustible aerosol provision device 10 for generating an aerosol from an article 100 comprising aerosol-generating material is illustrated in FIGS. 7A and 7B. In this embodiment, the heating system comprises an induction heating system 750. In this embodiment, the at least one part of the heating system comprises at least one induction coil 754. The induction heating system 650 is operable to cause heating of at least one susceptor 752. In the embodiment shown FIGS. 7A and 7B, the aerosol provision system 1 may comprise the induction heating system 850 comprising the at least one induction coil 754 and the at least one susceptor 752. In certain embodiments, the aerosol provision device 10 may comprise the induction heating system 850 comprising the at least one induction coil 754 and the article 100 may comprise the at least one susceptor 752.

FIGS. 7A and 7B illustrate the arrangement between the article 100, the at least one induction coil 754, and the at least one susceptor 752 schematically. In the embodiment of FIGS. 7A and 7B, the induction coil 754 is movable relative to the receptacle 40, which is not shown in the figures. The at least one susceptor 752 is fixed relative to the receptacle 40 when the article 100 is received in the receptacle 40. Thus, in certain examples, the induction coil 554 is movable relative to the susceptor 752. In the embodiment shown in FIG. 7, the at least one susceptor 752 is part of the article 100 and may, for example, and be fixed relative to the receptacle 40 and/or housing 12 when the article 100 is received in the receptacle 40.

FIG. 7A illustrates one possible example of an article 100 comprising aerosol-generating material. In this case, the article comprises a plurality of discrete portions 102 of aerosol-generating material. In the example shown, the discrete portions 102 are disposed on a support 110 to form a substrate. The substrate may also include the at least one susceptor 752. For example, the substrate may comprise a plurality of susceptors 752, each of which is associated with one of the discrete portions 102 of the plurality of portions of the aerosol-generating material. In certain embodiments, each susceptor 752 of the plurality of susceptors 752 may be associated with one or more of the discrete portions 102 of the plurality of portions of the aerosol-generating material.

In the example shown, the each susceptor 752 is located between the respective one of the discrete portions 102 of aerosol-generating material and the support 110. In other examples, each susceptor 752 may be located in other positions relative to the respective one of the discrete portions 102. For example, each susceptor 752 may be located on the opposing side of the support 110 to the respective one of the discrete portions 102. In such examples, each susceptor 752 may be aligned with the respective one of the discrete portions 102, for example by being underneath the respective one of the discrete portions 102. In certain embodiments, each susceptor 752 maybe sized to cover substantially the same area of the support 110. The susceptors 752 may be any material as described herein, for example, a foil such as an aluminium foil. In other examples, each susceptor 752 may located within or inside the respective one of the discrete portions 102 of aerosol-generating material. For example, each susceptor 752 may comprise heatable material, as described herein, mixed with the discrete portions 102 of aerosol-generating material.

In the case of the article 100 shown in FIG. 7A, the discrete portions 102 are arranged in two rows of discrete portions 102. It will be understood however, that any number of rows, columns, or patterns of discrete portions 102 may be disposed on the support 110.

When the induction coil 754 is energised with an alternating current, as described herein, the resulting varying magnetic field heats the at least one susceptor 752 that is located in a suitable position to be heated by the heating system. The at least one susceptor 752 may then be used to heat one or more of the discrete portions 102 of the aerosol-generating material of the article 100 when the device 10 is in use and an article 100 is received in the receptacle 40.

As the at least one induction coil 754 is moved relative to the receptacle 40 and/or housing 12, the at least one induction coil 754 can be used to heat different discrete portions 102 of the aerosol generating material. In certain examples, as shown in FIG. 7A, the article 100 may be a flat, or generally planer, shape. The article 100 may be rectangular in shape and have a length L, a shown in FIG. 7A. The induction coil 754 may be movable along at least a portion of the length of the article 100. When the article 100 is received in the receptacle 40, the at least one induction coil 754 may be movable in the lengthwise direction L shown in FIG. 7A. Thus, the at least one induction coil 754 may move along the length of the article 100 to positions where selected one of more discrete portions 102 of plurality of portions of the aerosol-generating material may be heatable by the heating system. For instance, the at least one induction coil 754 may be positioned proximate to the respective susceptor 752 corresponding to the selected one or more discrete portions 102 of aerosol-generating material and then the induction heating system 750 may be activated.

This arrangement may allow for a selected amount, particular flavor, active substance, or any desired combination of these to be delivered to a user. For instance, one discrete portion 102 of aerosol generating material may comprise a flavor and an immediately adjacent discrete portion 102 of aerosol generating material may comprise an active substance or different flavor and, when the at least one induction coil 754 is activated, the two adjacent discrete portions 102 may generate an aerosol combination that can be delivered to a user. In this way, an article 100 may be provided and used in the device 10 to provide a user with a variety of different aerosol combinations. For example, one article 100 may be able to provide a range of difference flavor combinations for a user to experience during use.

This arrangement may also allow the more efficient use of energy since the induction coil 754 and susceptor 752 may be arranged closely together in an efficient use of space. Furthermore, the susceptors 752 may be made quite small to minimise material wastage and reduce disposed waste in general.

In the example shown in FIG. 7B, the induction coil 754 of the induction heating system 550 is coiled, or wrapped, around the at least one susceptor 752. In FIG. 7B, the article 100 is schematically shown end-on located inside the induction coil 754 when received in the receptacle 40 not shown in FIGS. 7A and 7B). In the example shown in FIG. 7B, the at least one induction coil 754 takes the form of a flattened tube. In certain examples, the on induction coil 754 may be an elongate flattened tubular shape. In this way, the at least one induction coil 754 has a shape corresponding to the flat article 100. This allows for efficient transfer of energy to the at least one susceptor 752 during induction heating. The at least one induction coil 754 may have other suitable shapes, such as an elliptical shape, oval shape, or a rectangular shape with rounded corners, for example.

In certain embodiments, the induction coil 754 may extend only along a portion of the article 100. Thus, in this instance, when the article 100 is received in the receptacle 40, the induction coil 754 extends substantially along a part of the length of the article 100 corresponding to the discrete portions 102 of the aerosol-generating material that are to be heated.

As with the other examples described herein, the induction coil 754 may located insider or outside of the receptacle 40. In the example of the non-combustible aerosol provision device 10 shown in FIG. 7, the article 100 is located inside the induction coil 754 when the article 100 is received in the receptacle 40. In other examples, the article 100 may be located outside the induction coil 754 when the article 100 is received in the receptacle 40, for instance by taking the form of a hollow tube that fits over the induction coil 754 of the device 10.

As with the other examples described herein, in the embodiment of aerosol provision system 1 shown in FIGS. 7A and 7B, the device 10 may be provided with any of the described features, such as a mouthpiece element, air inlet, or lid.

Some embodiments of the device 10 of FIGS. 7A and 7B may include a selector 70. The selector 70 is operable to select one or more discrete portions 102 of the aerosol-generating material from the article 100 for heating by the at heating system as described herein. In certain embodiments, the device 10 may include a controller 80. The controller 80 may be connected to other components of the device 10 by circuitry, in the same way as described for the other examples described herein. The circuitry may also connect the controller 80 and/or power unit 84 to the induction heating system 750. For instance, the induction coil 754 may be connected to the controller 80 and power unit 84. In certain embodiments, the controller 80 may comprise the selector 70. In certain embodiments, the selector 70 may be separate from the controller 80.

In common with the other examples described herein, the device 10 may include an actuator 90, which is operable to drive the movement of the induction coil 754. In certain embodiments, the actuator 90 may be a linear actuator to drive translation of the induction coil 754 along the length of the receptacle 40 and therefore along the length of the article 100. In certain embodiments, the actuator 90 may be a rotary actuator to drive rotation of the induction coil 754 around the receptacle 40 and therefore around the outside of the article 100.

Another embodiment of an aerosol provision system 1 comprising a non-combustible aerosol provision device 10 for generating an aerosol from an article 100 comprising aerosol-generating material is shown in FIG. 8. In this embodiment of the system, the article 100 comprises the at least one part of the heating system and the non-combustible aerosol provision device 10 comprises other components of the heating system that cooperate with at least one part of the heating system. The aerosol-generating material may be stored in an aerosol-generating material storage area 102 of the article 100.

In this embodiment, the heating system comprises an induction heating system 850. The induction heating system 850 is operable to cause heating of the susceptor 852. In this embodiment, the susceptor 852 may be heated by induction heating as described herein. In the embodiment shown FIG. 8, the induction heating system 850 comprises an induction coil 854. In the embodiment of FIG. 8, the susceptor 852 is movable relative to the induction coil 854, which is fixed relative to the receptacle 40. The induction coil 854 may be mounted in the housing 12. The aerosol-generating material storage area 100 storing the aerosol-generating material may be arranged in proximity to the susceptor 852.

When the induction coil 854 is energised with an alternating current, as described herein, the resulting varying magnetic field heats the susceptor 852 of the article 100. The susceptor 852 may then be used to heat one or more portions of the aerosol-generating material of the article 100 when the device 10 is in use and an article 100 is received in the receptacle 40.

In the embodiment of the aerosol provision system shown in FIG. 8, the device 10 is provided with a mouthpiece 20 from which a user may inhale aerosol generated in the device 10. However, it will be understood that the article 100 may instead be provided with a mouthpiece element as described herein.

As with the non-combustible aerosol provision device 10 illustrated in FIGS. 1 and 2, the non-combustible aerosol provision device 10 shown in FIG. 8 includes an air inlet 30. A user inserts the article 100, in accordance with the examples described herein, into the receptacle 40 of non-combustible aerosol provision device 10 through an opening in the housing 12. For instance, in this example, the mouthpiece 20 may act as a lid covering user access to the receptacle 40 and allow insertion of the article 100 into the receptacle 40.

In the embodiment shown in FIG. 8, the receptacle 40 is shaped and arranged to receive an elongate article 100 and is open at one end to allow the article 100 to be inserted into the receptacle 40. It will be understood that the receptacle 40 may be shaped and arranged to receive other shapes of article 100 as described herein. The article 100 may include and engagement element 104 that mechanically engages with features of receptacle 40 to allow for the transmission of motive force to one or more components of the article 100.

In the example shown in FIG. 8, the induction coil 854 of the induction heating system 850 is coiled, or wrapped, around the susceptor 852 when the article 100 is received in the receptacle 40. In other examples, the induction coil 854 may be coiled inside the susceptor 852 when the article 100 is received in the receptacle 40. For instance, the article 100 may have a tubular shape that fits over a spigot in the receptacle. The spigot may contain the induction coil 854, for example.

In certain examples, the susceptor 852 may be take the form of a plate or flat element. In other examples, the susceptor 852 may be a hollow tube. The induction coil 854 may be also be an elongate tubular shape, for example a cylindrical tubular shape, that surrounds the susceptor 852. In FIG. 8, the induction coil 854 is shown in cross section through the axis of the tubular coil 854.

In this embodiment, the induction coil 854 extends along a portion of a length of the receptacle 40. Thus, in this instance, when the article 100 is received in the receptacle 40, the induction coil 854 extends along a portion of a length of the article 100. In this example, the non-combustible aerosol provision device 10 is arranged to accommodate an article 100 in which only a portion of the article 100 supports or includes aerosol-generating material, such as the aerosol-generating material storage area 102. In this instance, the article 100 accommodates the engagement element 104 that takes up a portion of the article 100 volume and therefore takes up a corresponding portion of the receptacle 40 volume when the article 100 is received in the receptacle 40.

In the example shown in FIG. 8, the induction coil 854 is located outside of the receptacle 40. In other examples, the induction coil 854 may be located inside the receptacle 40. In the example of the non-combustible aerosol provision device 10 shown in FIG. 8, the susceptor 852 is located inside the induction coil 454. In other words, the susceptor 852 may be located radially inward of the induction coil 854. For instance, the induction coil 854 is coiled or wrapped in a substantially cylindrical shape and the radial direction is defined relative to the by the cylindrical shape of the induction coil 454. In other examples, the susceptor 852 may be located outside the induction coil 854, such as in a radially outward direction of the induction coil 854.

In the embodiment shown in FIG. 8, the susceptor 852 is movable in the direction of arrows M along at least a portion of the length of the receptacle 40. Thus, when the article 100 is received in the receptacle 40, the susceptor 852 is movable along at least a portion of the length of the article 100. In this way the susceptor 852 may be moved backwards and forwards along the length of the article 100 so that selected one or more portions of the aerosol-generating material may be heated by the susceptor 852 by positioning the susceptor 852 proximate to the respective portion of aerosol-generating material and activating the induction heating system 850.

In certain embodiments, the device 10 of FIG. 4 may include a selector 70. The selector 70 is operable to select one or more portions of the aerosol-generating material from the article 100 for heating by the susceptor 852 as described herein.

In certain embodiments, the device 10 may include a controller 80. The controller 80 may be connected to other components of the device 10 by circuitry 82. For instance, the controller 80 may be connected via the circuitry 82 to a power unit 84 for supplying power to the device 10. The circuitry 82 may also connect the controller 80 and/or power unit 84 to the induction heating system 850. For instance, the induction coil 854 may be connected to the controller 80 and power unit 84.

In certain embodiments, the controller 80 may comprise the selector 70. In certain embodiments, the selector 70 may be separate from the controller 80. For instance, the selector 70 may be a user interface, such as a switch or touchscreen, through which a user can select one or more portions of the aerosol-generating material for heating by the susceptor 852. In some examples, the selector 70 may be connected to the controller, for instance via the circuitry 82.

The device 10 may include an actuator 90, which is operable to drive the movement of the susceptor 852. In certain embodiments, the actuator 90 may be a linear actuator to drive translation of the susceptor 852 along the length of the receptacle 40 and therefore along the length of the article 100. In the example shown in FIG. 8, the actuator 90 may comprise a worm gear 94 that engages with the engagement element 104 of the article 100 when it is received in the receptacle 40. Thus, the actuator 90 can be described as having components in both the article 100 and the device 10. For instance, the engagement element 104 may comprise a gear that is driven by the worm gear 94. In the example shown, the gear may act as a driver to push and pull a rigid belt 106 that acts to translate the susceptor 852 backwards and forwards in the direction of the arrow M.

It will be understood that other actuators could be employed to drive the motion of the susceptor 852. For instance, a rotary actuator, or a magnetic drive, could be employed to drive the motion of the susceptor 852.

The actuator 90 may be connected, via circuitry 82, to the controller 80 so that the controller 80 can control the motion of the susceptor 852 with respect to the receptacle 40.

Any of the non-combustible aerosol provision device embodiments described herein may be provided to a user as an aerosol provision system that contains at least one article for use with the non-combustible aerosol provision device. The aerosol provision system may contain a plurality of like articles for use with the non-combustible aerosol provision device.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A non-combustible aerosol provision device for generating an aerosol from an article comprising an aerosol-generating material, the device comprising:
a receptacle to receive, in use, the article;
a heating system for heating the aerosol-generating material when the article is received in the receptacle, wherein at least one part of the heating system and the receptacle are relatively movable;
a selector operable to select one or more portions of the aerosol-generating material, from a plurality of portions of the aerosol-generating material, for heating by the heating system; and
a controller configured to cause at least the part of the heating system to move relative to the receptacle to be positioned such that, in use, the one or more portions of the aerosol-generating material is, or are, heatable by the heating system.

2. The device according to claim 1, wherein the at least one part of the heating system is rotatable relative to the receptacle around a first axis of the receptacle.

3. The device according to claim 1, wherein the at least one part of the heating system is translatable relative to the receptacle in the direction of a second axis of the receptacle.

4. The device according to claim 1, wherein the at least one part of the heating system comprises a plurality of parts of the heating system and wherein each of the parts of the heating system is movable, in use, relative to the receptacle, to heat different ones of the plurality of portions of the aerosol-generating material.

5. The device according to claim 1, wherein the controller is configured to cause the at least one part of the heating system to heat the plurality of portions of the aerosol-generating material in a non-successive order. 6. The device according to any preceding claim, wherein the heating system comprises a resistive heating system and the at least one part is an electrically resistive heater.

6. (canceled)

7. The device according to claim 1, wherein the heating system comprises an induction heating system, comprising a susceptor and an induction coil operable to cause heating of the susceptor in use.

8. (canceled)

9. The device according to claim 7, wherein the at least one part comprises the susceptor wherein the induction coil is fixed in position relative to the receptacle.

10. The device according to claim 7, wherein the at least one part comprises the susceptor and the induction coil.

11. The device according to claim 10, wherein the induction coil is movable in unison with the susceptor.

12. The device according to claim 7, wherein the at least one part comprises the induction coil and the susceptor is fixed relative to the receptacle.

13. (canceled)

14. A non-combustible aerosol provision device for generating an aerosol from an article comprising an aerosol-generating material, the device comprising:
a receptacle to receive, in use, the article; and an induction heating system for causing heating of the aerosol-generating material when the article is received in the receptacle, the induction heating system comprising at least one of a susceptor and an induction coil;
wherein at least one of the susceptor and the induction coil is movable relative to the receptacle such that, in use, at least one portion of a plurality of portions of the aerosol-generating material is heatable by the induction heating system.

15. The device according to claim 14, wherein the susceptor and the induction coil are movable relative to the receptacle.

16. (canceled)

17. The device according to claim 14, wherein the induction coil is movable relative to the receptacle.

18. The device according to claim 17, wherein the induction heating system comprises the susceptor and the susceptor is fixed in position relative to the receptacle.

19. (canceled)

20. An aerosol provision system comprising: the non-combustible aerosol provision device according to claim 1; and at least one article comprising an aerosol-generating material, wherein the at least one article is shaped and sized to be receivable within the receptacle.

21. An aerosol provision system, the aerosol provision system comprising:
a non-combustible aerosol provision device;
an article comprising an aerosol-generating material; and
an induction heating system comprising at least one susceptor and at least one induction coil operable to cause heating of the susceptor in use,
wherein the non-combustible aerosol provision device comprises a receptacle to receive, in use, the article, the article shaped and sized to be receivable within the receptacle, the non-combustible aerosol provision device comprises the at least one induction coil, wherein the at least one induction coil and the receptacle are relatively movable, the article comprises the at least one susceptor.

22. The system according to claim 21, wherein the at least one susceptor comprises a plurality of susceptors, and wherein each of the susceptors is associated with one or more discrete portions of a plurality of portions of the aerosol-generating material.

23. (canceled)

24. A method of heating an aerosol-generating material, the method comprising:
receiving an article comprising an aerosol-generating material in a receptacle of a non-combustible aerosol provision device, the device comprising heating system for heating the aerosol-generating material;
selecting one or more portions of the aerosol-generating material, from a plurality of portions of the aerosol-generating material, for heating by the heating system;
moving at least one part of the heating system relative to the receptacle to be positioned such that the one or more portions of the aerosol-generating material is heatable by the heating system; and
heating the one or more portions of the aerosol-generating material, using the heating system.

25. The method according to claim 24, wherein the method comprises moving the at least one part of the heating system relative to the receptacle to be positioned such that a second portion of the aerosol-generating material is heatable by the heating system.

26. The method according to claim 25, wherein the method comprises:
re-selecting the one or more portions of the aerosol-generating material for heating by the heating system;
moving the at least one part of the heating system relative to the receptacle to be positioned such that the one or more portions of the aerosol-generating material is heatable by the heating system; and
re-heating the one or more portions of the aerosol-generating material using the heating system.
